(19) United States
(12) Patent Application Publication
(10) Pub. No.: US 2013/0062308 A1
(43) Pub. Date: Mar. 14, 2013

(54) METHOD OF MANUFACTURING MAGNETIC RECORDING HEAD

(71) Applicants: Tomomi FUNAYAMA, Fuchu-shi (JP); Masahiro TAKASHITA, Kawasaki-shi (JP); Yusuke TOMODA, Zama-shi (JP)

(72) Inventors: Tomomi FUNAYAMA, Fuchu-shi (JP); Masahiro TAKASHITA, Kawasaki-shi (JP); Yusuke TOMODA, Zama-shi (JP)

(73) Assignee: KABUSHIKI KAISHA TOSHIBA, Tokyo (JP)

(21) Appl. No.: 13/541,406

(22) Filed: Jul. 3, 2012

(30) Foreign Application Priority Data
Sep. 9, 2011 (JP) 2011-197261

(51) Int. Cl. G11B 5/84

(52) U.S. Cl. 216/22; 427/127

(57) ABSTRACT

According to one embodiment, a method of manufacturing a magnetic recording head includes forming a main pole, forming an oscillator forming layer includes an underlayer, a spin injection layer, an interlayer, an oscillator layer, and a cap layer on a trailing end surface and sidewalls of the main pole, and removing those parts of the oscillator forming layer which are formed on the sidewalls of the main pole, thereby forming a high-frequency oscillator which is aligned with a width of at least the trailing end surface of the main pole.

### CROSS-REFERENCE TO RELATED APPLICATIONS

This application is based upon and claims the benefit of priority from prior Japanese Patent Application No. 2011-197261, filed Sep. 9, 2011, the entire contents of which are incorporated herein by reference.

### FIELD

Embodiments described herein relate generally to a method of manufacturing a magnetic recording head used in a disk drive.

### BACKGROUND

A disk drive, such as a magnetic disk drive, comprises a magnetic disk, spindle motor, magnetic head, and carriage assembly. The magnetic disk is disposed in a case. The spindle motor supports and rotates the disk. The magnetic head reads data from and writes data to the disk. The carriage assembly supports the head for movement relative to the disk. A head section of the magnetic head comprises a recording head for writing and a reproduction head for reading.

Magnetic heads for perpendicular magnetic recording have recently been proposed in order to increase the recording density and capacity of a magnetic disk drive or reduce its size. In one such magnetic head, a recording head comprises a main pole configured to produce a perpendicular magnetic field, trailing shield, and coil. The trailing shield is located on the trailing side of the main pole with a write gap therebetween. The coil serves to pass magnetic flux through the main pole.

To improve the recording density, a microwave-assisted magnetic recording head is proposed in which a spin-torque oscillator for use as a high-frequency oscillator is disposed between the main pole and trailing shield such that a high-frequency magnetic field from the oscillator is applied to a magnetic recording layer.

In order to ensure good writing characteristics for the microwave-assisted magnetic recording head, the dislocation between the main pole and spin-torque oscillator must be small for the following reason. Data is written in a region where the recording magnetic field from the main pole overlaps the high-frequency magnetic field produced by the spin-torque oscillator. If the main pole and oscillator are dislocated from each other, therefore, the magnetic fields from them fail to overlap each other, so that satisfactory writing cannot be achieved. On the other hand, the spin-torque oscillator and the top portion of the main pole are 50 nm wide or less. It is therefore very difficult to align the main pole and oscillator with each other in a conventional photolithographic process.

### BRIEF DESCRIPTION OF THE DRAWINGS

FIG. 1 is a perspective view showing a magnetic disk drive (HDD) according to a first embodiment;

FIG. 2 is a side view showing a magnetic head and suspension of the HDD;

FIG. 3 is an enlarged sectional view showing a head section of the magnetic head;

FIG. 4 is an enlarged sectional view showing the disk-side end portion of the recording head;

FIG. 5 is a plan view of the recording head taken from the ABS side of a slider;

FIG. 6 is a plan view showing a manufacturing process for the recording head;

FIG. 7 is a plan view showing a manufacturing process for the recording head;

FIG. 8 is a plan view showing a manufacturing process for the recording head;

FIG. 9 is a plan view showing a manufacturing process for the recording head;

FIG. 10 is a plan view showing a manufacturing process for the recording head;

FIG. 11 is a plan view showing a manufacturing process for the recording head;

FIG. 12 is a plan view showing a manufacturing process for a recording head according to a first modification;

FIG. 13 is a plan view showing a manufacturing process for the recording head according to the first modification;

FIG. 14 is a plan view showing a manufacturing process for a recording head according to a second modification;

FIG. 15 is a plan view showing a manufacturing process for the recording head according to the second modification;

FIG. 16 is a plan view showing a manufacturing process for a recording head according to a second embodiment; and

FIG. 17 is a plan view showing a manufacturing process for the recording head according to the second embodiment.

### DETAILED DESCRIPTION

In general, according to one embodiment, a method of manufacturing a magnetic recording head, which comprises a main pole configured to apply a recording magnetic field, a trailing shield located opposite the main pole with a gap therebetween, and a high-frequency oscillator between the main pole and the trailing shield and configured to produce a high-frequency magnetic field, comprises: forming the main pole; forming an oscillator forming layer comprising an underlayer, a spin injection layer, an interlayer, an oscillator layer, and a cap layer on a trailing end surface and sidewalls of the main pole; and removing those parts of the oscillator forming layer which are formed on the sidewalls of the main pole, thereby forming the high-frequency oscillator which is aligned with a width of at least the trailing end surface of the main pole.

### First Embodiment

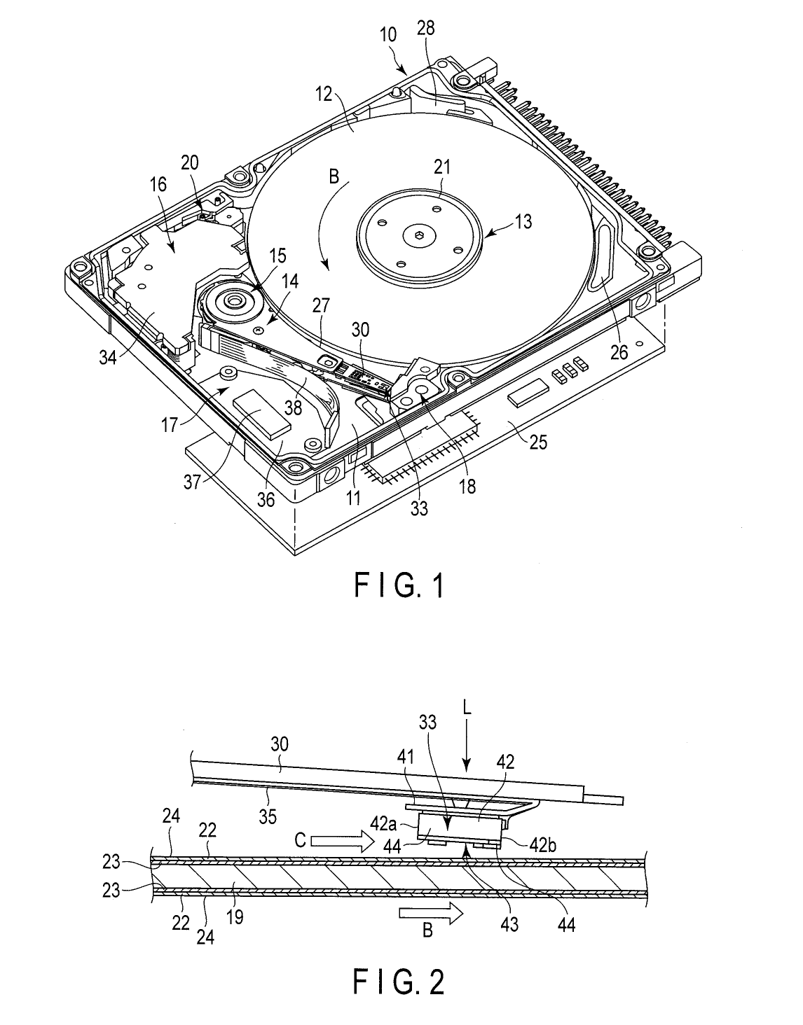

FIG. 1 shows the internal structure of an HDD, for use as a disk drive comprising a magnetic recording head, with its top cover removed, and FIG. 2 shows a flying magnetic head. As shown in FIG. 1, the HDD comprises a housing 10. The housing 10 comprises a base 11 in the form of an open-topped rectangular box and a top cover (not shown) in the form of a rectangular plate. The top cover is attached to the base by screws such that it closes the top opening of the base. Thus, the housing 10 is kept airtight inside and can be ventilated through a breather filter 26 only.

The base 11 carries thereon a magnetic disk 12, for use as a recording medium, and a mechanical unit. The mechanical unit comprises a spindle motor 13, a plurality (e.g., two) of magnetic heads 33, head actuator 14, and voice coil motor (VCM) 16. The spindle motor 13 supports and rotates the magnetic disk 12. The magnetic heads 33 record and reproduce data on and from the disk 12. The head actuator 14 supports the heads 33 for movement relative to the surfaces of the disk 12. The VCM 16 pivots and positions the head actuator. The base 11 further carries a ramp loading mechanism 18, inertial latch 20, and board unit 17. The ramp loading mechanism 18 holds the magnetic heads 33 in a position off the magnetic disk 12 when the heads are moved to the outermost periphery of the disk. The inertial latch 20 holds the head actuator 14 in a retracted position if the HDD is jolted, for example. Electronic components, such as a preamplifier, head IC, etc., are mounted on the board unit 17.

A control circuit board 25 is attached to the outer surface of the base 11 by screws such that it faces a bottom wall of the base. The circuit board 25 controls the operations of the spindle motor 13, VCM 16, and magnetic heads 33 through the board unit 17.

As shown in FIGS. 1 and 2, the magnetic disk 12 is constructed as a perpendicular magnetic recording film medium. The magnetic disk 12 comprises a substrate 19 formed of a nonmagnetic disk with a diameter of, for example, about 2.5 inches. A soft magnetic layer 23 for use as an underlayer is formed on each surface of the substrate 19. The soft magnetic layer 23 is overlain by a perpendicular magnetic recording layer 22, which has a magnetic anisotropy perpendicular to the disk surface. Further, a protective film 24 is formed on the recording layer 22.

As shown in FIG. 1, the magnetic disk 12 is coaxially fitted on the hub of the spindle motor 13 and clamped and secured to the hub by a clamp spring 21, which is attached to the upper end of the hub by screws. The disk 12 is rotated at a predetermined speed in the direction of arrow B by the spindle motor 13 for use as a drive motor.

The head actuator 14 comprises a bearing 15 secured to the bottom wall of the base 11 and a plurality of arms 27 extending from the bearing. The arms 27 are arranged parallel to the surfaces of the magnetic disk 12 and at predetermined intervals and extend in the same direction from the bearing 15. The head actuator 14 comprises elastically deformable suspensions 30 each in the form of an elongated plate. Each suspension 30 is formed of a plate spring, the proximal end of which is secured to the distal end of its corresponding arm 27 by spot welding or adhesive bonding and which extends from the arm. Each magnetic head 33 is supported on the extended end of its corresponding suspension 30 by a gimbal spring 41.

As shown in FIG. 2, each magnetic head 33 comprises a substantially cuboid slider 42 and read/write head section 44 on an outflow end (trailing end) of the slider. A head load L directed to the surface of the magnetic disk 12 is applied to each head 33 by the elasticity of the suspension 30. The two arms 27 are arranged parallel to and spaced apart from each other, and the suspensions 30 and heads 33 mounted on these arms face one another with the magnetic disk 12 between them.

Each magnetic head 33 is electrically connected to a main FPC 38 (described later) through a relay flexible printed circuit (FPC) board 35 secured to the suspension 30 and arm 27.

As shown in FIG. 1, the board unit 17 comprises an FPC main body 36 formed of a flexible printed circuit board and the main FPC 38 extending from the FPC main body. The FPC main body 36 is secured to the bottom surface of the base 11. The electronic components, including a preamplifier 37 and head IC, are mounted on the FPC main body 36. An extended end of the main FPC 38 is connected to the head actuator 14 and also connected to each magnetic head 33 through each relay FPC 35.

The VCM 16 comprises a support frame (not shown) extending from the bearing 15 in the direction opposite to the arms 27 and a voice coil supported on the support frame. When the head actuator 14 is assembled to the base 11, the voice coil is located between a pair of yokes 34 that are secured to the base 11. Thus, the voice coil, along with the yokes and a magnet secured to one of the yokes, constitutes the VCM 16.

If the voice coil of the VCM 16 is energized with the magnetic disk 12 rotating, the head actuator 14 pivots, whereupon each magnetic head 33 is moved to and positioned on a desired track of the disk 12. As this is done, the head 33 is moved radially relative to the disk 12 between the inner and outer peripheral edges of the disk.

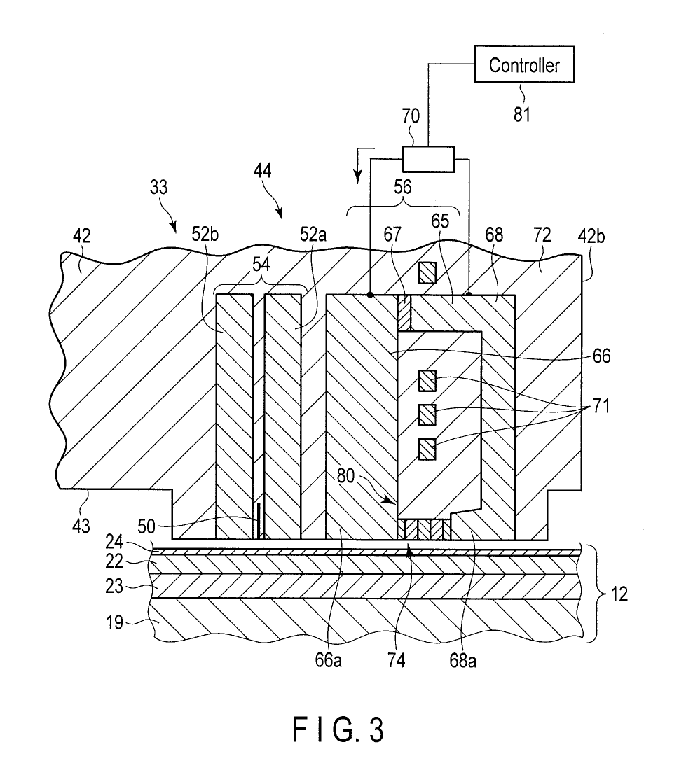

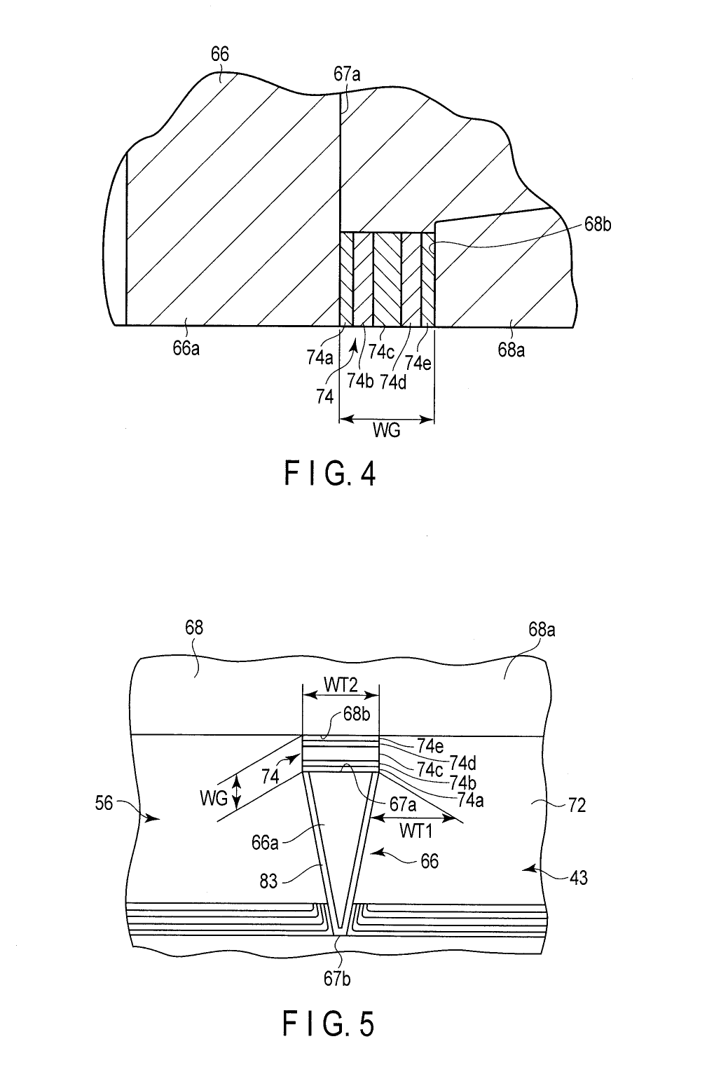

The following is a detailed description of a configuration of one of the magnetic heads 33. FIG. 3 is an enlarged sectional view showing the head section 44 of the head 33, FIG. 4 is an enlarged sectional view showing the disk-side end portion of the magnetic recording head, and FIG. 5 is a plan view of the recording head taken from the ABS side of the slider.

As shown in FIGS. 2 and 3, the magnetic head 33 is constructed as a flying head, which comprises the substantially cuboid slider 42 and head section 44 formed on the outflow or trailing end of the slider. The slider 42 is formed of, for example, a sintered body (AlTic) containing alumina and titanium carbide, and the head section 44 is formed by laminating thin films.

The slider 42 has a rectangular disk-facing surface or air-bearing surface (ABS) 43 configured to face a surface of the magnetic disk 12. The slider 42 is kept flying a predetermined distance from the disk surface by airflow C that is produced between the disk surface and the ABS 43 as the disk 12 rotates. The direction of airflow C is coincident with the direction of rotation B of the disk 12. The slider 42 is disposed on the surface of the disk 12 in such a manner that the longitudinal direction of the ABS 43 is substantially coincident with the direction of airflow C.

The slider 42 comprises leading and trailing ends 42a and 42b on the inflow and outflow sides, respectively, of airflow C. The ABS 43 of the slider 42 is formed with leading and trailing steps, side steps, negative-pressure cavity, etc., which are not shown.

As shown in FIGS. 3 and 4, the head section 44 is constructed as a dual-element magnetic head, comprising a reproduction head 54 and recording head 56 formed on the trailing end 42b of the slider 42 by thin-film processing.

The reproduction head 54 comprises a magnetic film 50 having a magnetoresistive effect and shielding films 52a and 52b disposed on the trailing and leading sides, respectively, of the magnetic film such that they sandwich the magnetic film between them. The respective lower ends of the magnetic film 50 and shielding films 52a and 52b are exposed in the ABS 43 of the slider 42.

The recording head 56 is located nearer to the trailing end 42b of the slider 42 than the reproduction head 54. The recording head 56 comprises a main pole 66 of a high-saturation-magnetization material, trailing shield (or return pole) 68, recording coil 71, and spin-torque oscillator 74 as a high-frequency oscillator. The main pole 66 produces a recording magnetic field perpendicular to the surfaces of the magnetic disk 12. The trailing shield 68 is located on the trailing side of the main pole 66 and serves to efficiently close a magnetic path through the soft magnetic layer 23 just below the main pole. The recording coil 71 is located so that it is wound around the magnetic path including the main pole 66 and trailing shield 68 to pass magnetic flux to the main pole while a signal is being written to the magnetic disk 12. The spin-torque oscillator 74 is disposed between the distal end portion 66a of the main pole 66 and the trailing shield 68.

A power supply 70 is connected to the main pole 66 and trailing shield 68, and a current circuit is constructed such that current from the first power supply can be supplied in series through the trailing shield.

The main pole 66 extends substantially perpendicular to the surfaces of the magnetic disk 12. The lower end portion of the main pole 66 on the disk side is tapered toward the magnetic disk 12, and its distal end portion 66a is in the form of a pillar narrower than the other part. As shown in FIG. 5, the distal end portion 66a of the main pole 66 has, for example, a trapezoidal cross-section and comprises a trailing end surface 67a, leading end surface 67b facing the trailing end surface, and opposite side surfaces. The trailing end surface 67a has a predetermined width and is located on the trailing end side. The leading end surface 67b is narrower than the trailing end surface 67a. The lower end surface of the main pole 66 is exposed in the ABS 43 of the slider 42. Width WT1 of the trailing end surface 67a is substantially equal to the track width of the magnetic disk 12.

As shown in FIG. 3, the trailing shield 68 is substantially U-shaped and its distal end portion 68a has an elongated rectangular shape. The distal end surface of the trailing shield 68 is exposed in the ABS 43 of the slider 42. A leading end surface 68b of the distal end portion 68a extends transversely relative to the track of the magnetic disk 12. The end surface 68b is opposed substantially parallel to a trailing end surface 67a of the main pole 66 with write gap WG therebetween.

The trailing shield 68 comprises a junction 65 located near the upper part of the main pole 66 in a position off write gap WG or the ABS 43 of the slider 42. The junction 65 is connected to the main pole 66 by a back gap portion 67 formed of an insulator, such as SiO₂. This insulator electrically insulates the main pole 66 and trailing shield 68 from each other. Thus, by using the insulator for the back gap portion 67, current from the power supply 70 can be efficiently applied to the spin-torque oscillator 74 through the main pole 66 and trailing shield 68 that serve also as electrodes of the spin-torque oscillator 74. Al₂O₃ may be used in place of SiO₂ as the insulator for the back gap portion 67.

As shown in FIGS. 3 to 5, the spin-torque oscillator 74 is interposed between the trailing end surface 67a of the distal end portion 66a of the main pole 66 and the leading end surface 68b of the trailing shield 68 and arranged parallel to these end surfaces. Specifically, the spin-torque oscillator 74 is positioned within the range of width WT1 of the distal end portion 66a transversely relative to the track, in write gap WG. Length WT2 of the spin-torque oscillator 74 transversely relative to the track is equal to length WT1 of the trailing end surface 67a of the main pole 66 transversely relative to the track.

The spin-torque oscillator 74 is formed by, for example, sequentially laminating an underlayer 74a, spin injection layer (second magnetic layer) 74b, interlayer 74c, oscillator layer (first magnetic layer) 74d, and cap layer (protective layer) 74e, from the side of the main pole 66 to the side of the trailing shield 68. The underlayer 74a is, for example, a laminated film of Ta/Ru, and the spin injection layer 74b is an artificial lattice film of Co/Ni. The interlayer 74c is a Cu layer, the oscillator layer 74d is an Fe—Co—Al-based magnetic alloy film, and the cap layer 74e is a laminated film of Cu/Ru. The underlayer 74a and cap layer 74e are connected to the main pole 66 and trailing shield 68, respectively, which serve also as electrodes.

A soft magnetic material should preferably be used for the oscillator layer 74d. It may be selected from materials including, besides an Fe—Co—Al-based alloy, an alloy containing Ni, Fe and/or Co, such as Ni—Fe, Fe—Co—Si, Fe—Ni—Co, Co—Fe, or Fe—Si, an artificial lattice magnetic layer consisting of laminated alloys containing Ni, Fe and/or Co, such as Fe—Co/Ni, Fe/Ni, or Fe—Co, a Whistler alloy, such as Co—Mn—Si, Co—Fe—Mn—Si, Co—Fe—Al—Si, Co—Mn—Al, Co—Mn—Ga—Sn, Co—Mn—Ga—Ge, Co—Cr—Fe—Si, or Co—Fe—Cr—Al, and the like.

A material having perpendicular magnetic anisotropy should preferably be used for the spin injection layer 74b. It may be suitably selected from materials with high perpendicular magnetic anisotropy including Co—Cr-based magnetic layers, such as Co—Cr—Pt, Co—Cr—Ta, Co—Cr—Ta—Pt, and Co—Cr—Ta—Nb; rare earth (RE)-transition metal (TM)-based alloy magnetic layers, such as Tb—Fe—Co; artificial lattice magnetic layers of a Co-based alloy and alloys using Pd, Pt, Ni and other platinum group metals, such as Co/Pd, Co/Pt, Co—Cr—Ta/Pd, Co/Ni, and Co/Ni—Pt; Co—Pt— or Fe—Pt-based alloy magnetic layers; Sm—Co-based alloy magnetic layers, etc.

The material of the interlayer 74c may be a precious metal, such as copper, platinum, gold, silver, palladium, or ruthenium, or a nonmagnetic transition metal, such as chromium, rhodium, molybdenum, or tungsten. Further, the interlayer 74c may be a current confinement structure consisting of an alumina base material and copper or Ni—Fe-based alloy.

The materials and sizes of the oscillator layer 74d, spin injection layer 74b, and interlayer 74c are optionally selectable.

Although the spin injection layer 74b, interlayer 74c, and oscillator layer 74d are stacked in the order named, the oscillator layer, interlayer, and spin injection layer may alternatively be stacked in this order. In this case, the distance between the main pole 66 and oscillator layer 74d is reduced, so that a range in which a recording magnetic field produced by the main pole and a high-frequency magnetic field produced by the oscillator layer are efficiently superposed is enlarged over the medium, thereby enabling satisfactory recording.

The spin-torque oscillator 74 has its distal end exposed in the ABS 43 and is disposed flush with the distal end surface of the main pole 66 with respect to the surface of the magnetic disk 12. Under the control of the control circuit board 25, the spin-torque oscillator 74 is supplied with direct current along its film thickness as voltage from the first power supply 70 is applied to the main pole 66 and trailing shield 68. By this current supply, the magnetization of the oscillator layer of the spin-torque oscillator 74 can be rotated to produce a high-frequency magnetic field. In this way, the high-frequency magnetic field is applied to the recording layer of the magnetic disk 12. Thus, the main pole 66 and trailing shield 68 serve also as electrodes for perpendicular energization of the spin-torque oscillator 74.

A protective insulating film 72 covers the entire area of the reproduction head 54 and recording head 56 formed in the above-described manner except those parts which are exposed in the ABS 43 of the slider 42. The insulating film 72 forms the external shape of the head section 44.

The following is a description of a manufacturing method for the recording head 56 of the magnetic head 33 constructed in this manner.

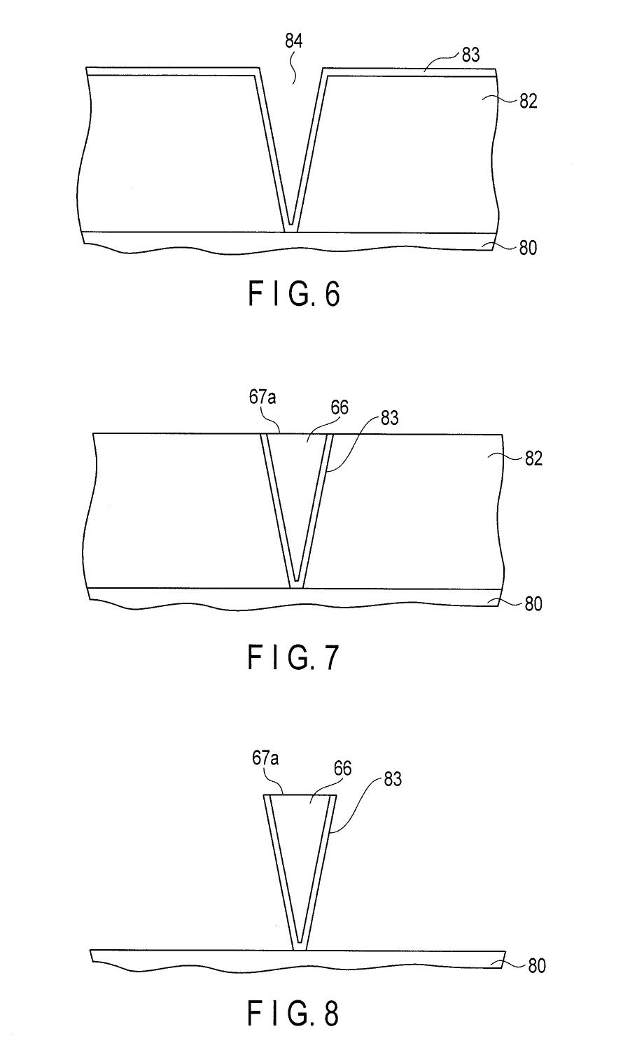

FIGS. 6 to 11 are views illustrating the manufacturing method for the recording head 56 in the order of processes. After the reproduction head 54 of the magnetic head 33 is first formed by lamination, as shown in FIG. 6, an underlayer 80 is formed superposed on it, and a plating frame 82 for main pole plating is further formed on the underlayer 80. The plating frame 82 is formed of a resist. Alternatively, however, a similar plating frame may be formed by forming a trench 84 in an insulating film by reactive ion etching (RIE) or the like. Then, a seed layer 83 for plating is formed on the plating frame 82.

Subsequently, as shown in FIG. 7, a main pole layer of a high-saturation-magnetization material is formed superposed on the seed layer 83, and thereafter, the respective surfaces of the main pole layer, seed layer 83, and plating frame 82 are planarized by chemical mechanical polishing (CMP), whereupon the main pole 66 is formed.

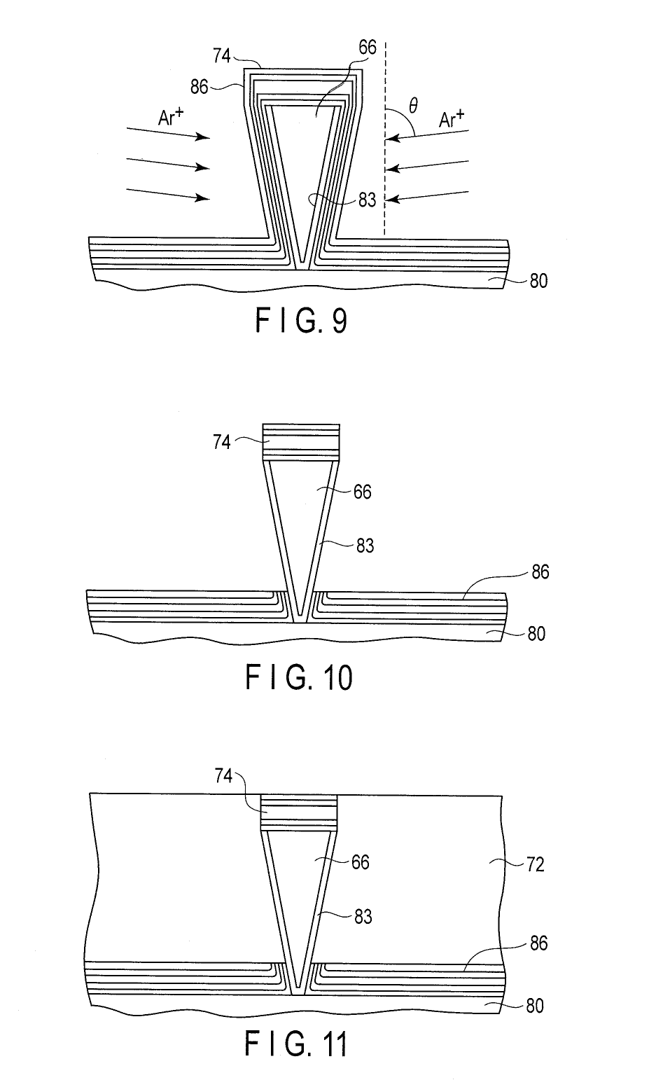

Then, as shown in FIG. 8, the plating frame 82 is removed by an organic solvent, RIE, ion milling, or the like, whereby the sidewalls of the main pole 66 and seed layer 83 are exposed. Subsequently, as shown in FIG. 9, the underlayer 74a, spin injection layer (second magnetic layer) 74b, interlayer 74c, oscillator layer (first magnetic layer) 74d, and cap layer (protective layer) 74e, which are to form the spin-torque oscillator 74, are sequentially formed and laminated so as to cover the main pole 66, seed layer 83, and underlayer 80, whereupon a spin-torque oscillator forming layer 86 is formed.

Thereafter, that part of the spin-torque oscillator forming layer 86 which is formed over the underlayer 80 and those parts which are laminated to the side surfaces of the main pole 66 are removed by argon-ion milling. This ion milling is performed at a milling angle θ of 60 to 90° to the direction perpendicular to the underlayer 80. By doing this, only those films which are attached to the sidewall portions of the main pole 66 and seed layer 83 can be removed so that the laminated films (spin-torque oscillator 74) formed on the trailing end surface of the main pole 66 can be left in a conformable manner. The spin-torque oscillator forming layer 86 may be designed so that it partially remains on the underlayer 80.

The amount of etching of the cap layer (protective layer) 74e of the spin-torque oscillator 74 on the main pole 66, which is based on the removal of those parts attached to the sidewalls of the main pole and oscillator, is calculated according to the ion milling rate. If the total film thickness of the spin-torque oscillator 74 is assumed to be about 30 nm, the film thickness of the cap layer should be at least a little more than 20% of the total film thickness of the spin-torque oscillator. If the calculation is based on such severe conditions that the ratio of the film thickness of the cap layer is 23%, there remains hardly any trace of the cap layer on the main pole when the sidewalls are removed. If the ratio of the film thickness of the cap layer is increased to about 30%, the cap layer remains 2 to 3 nm thick. If the thickness ratio is 35%, the remaining cap layer is about 5 nm thick. In consideration of the next process, the remaining cap layer 74e should preferably be at least about 2 nm. To attain this, the thickness ratio of cap layer to the spin-torque oscillator forming layer 86 is adjusted to 30% or more, and preferably to about 35%. The film thickness ratio is adjusted to 13% to leave the cap layer 74e 2 nm thick, and to 20% to leave the layer 5 nm thick. Thus, the film thickness ratio of the cap layer to the oscillator forming layer 86 should be adjusted to at least 15%, and preferably to 20 to 30%. A thickness ratio of 40% or more is a redundant condition.

As described above, those parts of the spin-torque oscillator forming layer 86 which are attached to the sidewalls of the main pole 66 and spin-torque oscillator 74 are removed. Thereupon, the spin-torque oscillator 74 remains on the main pole 66, and the main pole 66 and spin-torque oscillator 74 are formed in self-alignment, as shown in FIG. 10. Subsequently, as shown in FIG. 11, the sidewall portions of the main pole 66 and spin-torque oscillator 74 are buried in the insulating film 72, and the surfaces are planarized by CMP to polish out the spin-torque oscillator 74. As shown in FIG. 5, moreover, the trailing shield 68 is formed by lamination such that it is connected to the spin-torque oscillator 74. Thereafter, the magnetic head 33 comprising the recording head 56 is formed by forming the protective layer on top of the trailing shield 68.

According to the manufacturing method for the magnetic recording layer described above, the spin-torque oscillator 74 and main pole 66 can be formed in self-alignment without dislocation regardless of the positioning accuracy of a photolithographic process. Thus, the recording magnetic field from the main pole 66 and the high-frequency magnetic field produced by the spin-torque oscillator 74 overlap each other without deviation, so that the magnetic recording head can be manufactured that is capable of satisfactory microwave-assisted recording and excellent in writing characteristics.

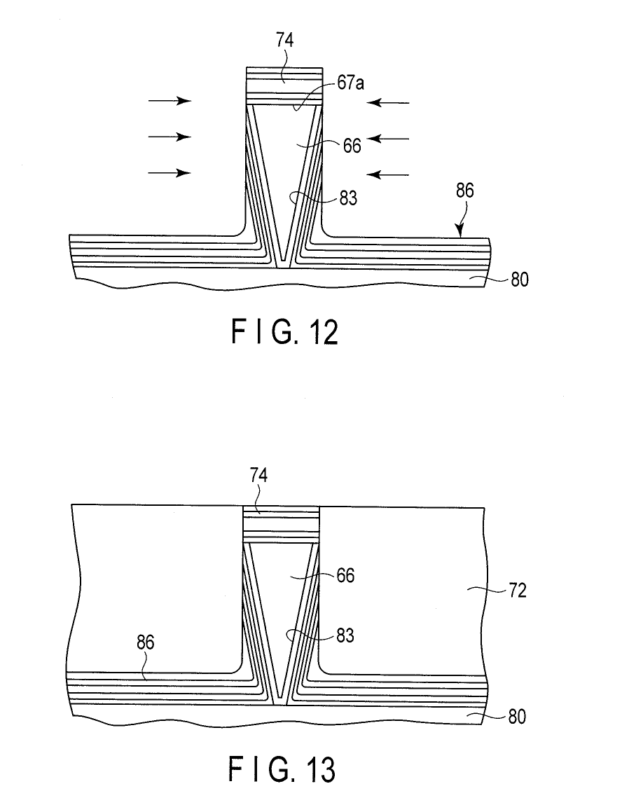

In the first embodiment, the spin-torque oscillator forming layer formed on the side surface of the main pole 66 is removed. As in a first modification shown in FIG. 12, for example, however, only those parts of the spin-torque oscillator forming layer 86 which are attached to the sidewalls of the spin-torque oscillator 74 and the sidewall of the main pole 66 on the side of the spin-torque oscillator 74 may be removed. In this case, the removal is performed so that the high-frequency oscillator is separated from that part of the oscillator forming layer which remains on the sidewall of the main pole 66. Thus, the spin-torque oscillator 74 remains on the main pole 66, and the main pole 66 and spin-torque oscillator 74 are formed in self-alignment. Subsequently, as shown in FIG. 13, the sidewall portions of the main pole 66 and spin-torque oscillator 74 are buried in the insulating film 72, and the surfaces are planarized by CMP to polish out the spin-torque oscillator 74. Thereafter, the magnetic recording head is formed in the same processes as those in the first embodiment.

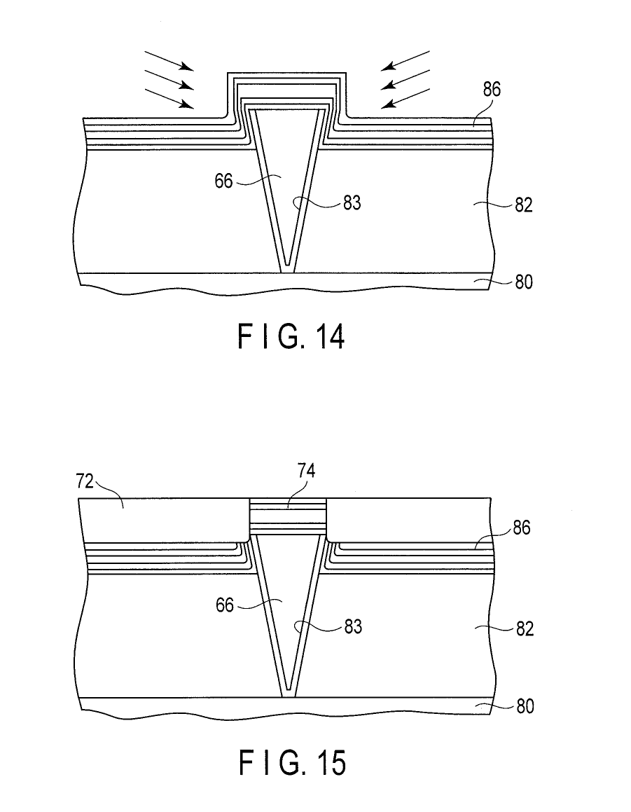

In the first embodiment described above, the plating frame 82 is thoroughly removed by an organic solvent, RIE, ion milling, or the like, whereby the entire sidewalls of the main pole 66 and seed layer 83 are exposed. As in a second modification shown in FIG. 14, for example, however, the plating frame 82 may be removed for a reduction equivalent to the thickness of the spin-torque oscillator forming layer at the least. Thereafter, in this case, the underlayer 74a, spin injection layer 74b, interlayer 74c, oscillator layer 74d, and cap layer 74e, which are to form the spin-torque oscillator 74, are sequentially formed and laminated so as to cover the main pole 66, seed layer 83, plating frame 82, and underlayer 80, whereupon the spin-torque oscillator forming layer 86 is formed.

Thereafter, as shown in FIGS. 14 and 15, that part of the spin-torque oscillator forming layer 86 which is formed over the underlayer 80 and those parts which are laminated to the side surfaces of the main pole 66 are removed by argon-ion milling. This ion milling is performed at a milling angle θ of 60 to 90° to the direction perpendicular to the underlayer 80. By doing this, only those films which are attached to the sidewall portions of the main pole 66 and seed layer 83 can be removed so that the laminated films (spin-torque oscillator 74) formed on the trailing end surface of the main pole 66 can be left in a conformable manner.

Subsequently, as shown in FIG. 15, the sidewall portions of the main pole 66 and spin-torque oscillator 74 are buried in the insulating film 72, and the surfaces are planarized by CMP to polish out the spin-torque oscillator 74. As shown in FIG. 5, moreover, the trailing shield 68 is formed by lamination such that it is connected to the spin-torque oscillator 74. Thereafter, the magnetic head 33 comprising the recording head 56 is formed by forming the protective layer on top of the trailing shield 68.

In the first and second modifications described above, the spin-torque oscillator 74 and main pole 66 can be in self-alignment without dislocation regardless of the positioning accuracy of the photolithographic process. Thus, the recording magnetic field from the main pole 66 and the high-frequency magnetic field produced by the spin-torque oscillator 74 overlap each other without deviation, so that the magnetic recording head can be manufactured that is capable of satisfactory microwave-assisted recording and excellent in writing characteristics.

The following is a description of a manufacturing method for a magnetic recording head according an alternative embodiment. In the description of the alternative embodiment to follow, like reference numbers are used to designate the same parts as those of the first embodiment, and a detailed description thereof is omitted. Different parts will be mainly described in detail.

### Second Embodiment

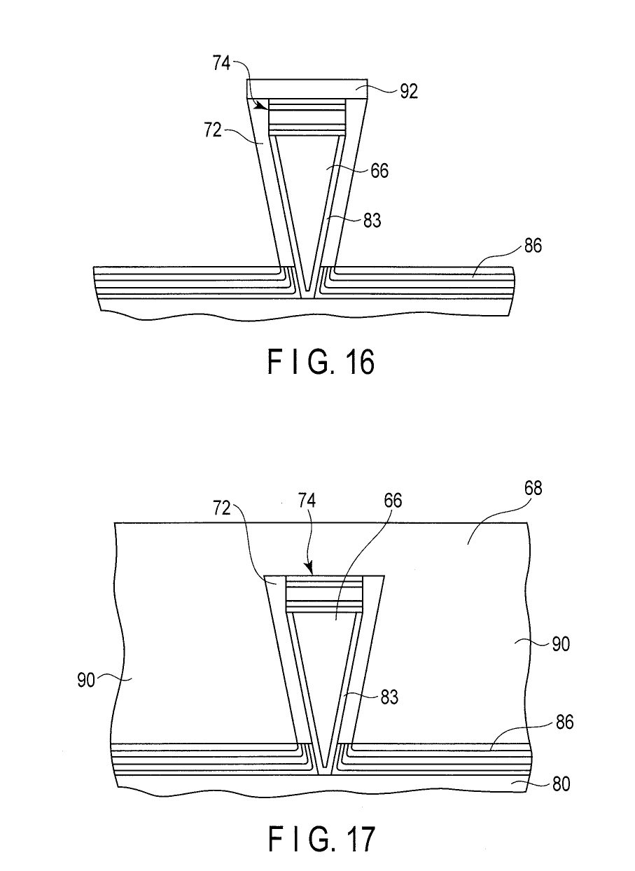

FIGS. 16 and 17 show manufacturing processes for a magnetic recording head of an HDD according to a second embodiment. The present embodiment differs from the first embodiment in that side shields are provided in addition to a trailing shield. As shown in FIG. 17, side shields 90 are arranged individually on the opposite sides of a main pole 66 with magnetic gaps therebetween. The side shields 90 may be formed integrally with, for example, a trailing shield 68. The side shields 90 serve to suppress spreading of a recording magnetic field, so that fringes can be reduced in addition to the effects of the first embodiment.

According to the method of manufacturing a microwave-assisted magnetic head 33 of the present embodiment, the processes shown in FIGS. 6 to 11 are the same as those described in connection with the first embodiment. Then, as shown in FIG. 16, a resist 92 is formed on a spin-torque oscillator 74 such that it is wider than the oscillator, and an insulating film 72 is etched by RIE or the like. In this way, an insulating film with a predetermined width is left on each side portion of the main pole 66. Subsequently, as shown in FIG. 17, the side shields 90 and trailing shield 68 are collectively formed on top of the spin-torque oscillator 74 and insulating film 72.

According to the magnetic recording head formed in this manner, a recording magnetic field from the main pole 66 and a high-frequency magnetic field produced by the spin-torque oscillator 74 overlap each other without deviation, so that writing can be performed well, and in addition, fringes can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of manufacturing a magnetic recording head, which comprises a main pole configured to apply a recording magnetic field, a trailing shield located opposite the main pole with a gap therebetween, and a high-frequency oscillator between the main pole and the trailing shield and configured to produce a high-frequency magnetic field, the method comprising:
forming the main pole;
forming an oscillator forming layer comprising an underlayer, a spin injection layer, an interlayer, an oscillator layer, and a cap layer on a trailing end surface and sidewalls of the main pole; and
removing those parts of the oscillator forming layer which are formed on the sidewalls of the main pole, thereby forming the high-frequency oscillator which is aligned with a width of at least the trailing end surface of the main pole.

2. The method of claim 1, wherein the removing those parts of the oscillator forming layer comprises ion milling the oscillator forming layer at an angle of 60 to 90° to a direction perpendicular to the trailing end surface of the main pole.

3. The method of claim 2, wherein the forming the oscillator forming layer comprises forming the cap layer in a film thickness ranging from 15 to 40% of a film thickness of the oscillator forming layer.

4. The method of claim 2, wherein the removing those parts of the oscillator forming layer comprises removing only those parts of the oscillator forming layer which are attached to sidewalls of the high-frequency oscillator and the sidewall of the main pole on the side of the high-frequency oscillator and separating the high-frequency oscillator from that part of the oscillator forming layer which remains on the sidewall of the main pole.

5. The method of claim 1, which further comprises forming the trailing shield by lamination such that the trailing shield is connected to the high-frequency oscillator, after the main pole and the high-frequency oscillator are formed.

6. The method of claim 1, wherein the removing those parts of the oscillator forming layer comprises removing only those parts of the oscillator forming layer which are attached to sidewalls of the high-frequency oscillator and the sidewall of the main pole on the side of the high-frequency oscillator and separating the high-frequency oscillator from that part of the oscillator forming layer which remains on the sidewall of the main pole.
